(19) United States
(12) Patent Application Publication
(10) Pub. No.: US 2011/0309985 A1
(43) Pub. Date: Dec. 22, 2011

(54) WIDEBAND PRINTED CIRCUIT BOARD-PRINTED ANTENNA FOR RADIO FREQUENCY FRONT END CIRCUIT

(76) Inventors: ZIMING HE, Irvine, CA (US); Ping Peng, Irvine, CA (US); Oleksandr Gorbachov, Irvine, CA (US)

(21) Appl. No.: 13/164,453

(22) Filed: Jun. 20, 2011

Related U.S. Application Data
(60) Provisional application No. 61/357,020, filed on Jun. 21, 2010.
(60) Provisional application No. 61/357,017, filed on Jun. 21, 2010.
(60) Provisional application No. 61/357,012, filed on Jun. 21, 2010.

(51) Int. Cl. H01Q 1/38

(52) U.S. Cl. 343/700 MS

(57) ABSTRACT

A printed circuit board (PCB)-printed antenna for a radio frequency (RF) front end with an antenna port for a predefined operating frequency band. A radiating element with a first branch defined by a first set of dimensions corresponding to a minimum frequency and a second branch defined by a second set of dimensions corresponding to a maximum frequency is fixed to a PCB substrate. A third branch is defined by a third set of dimensions corresponding to a middle frequency in various embodiments. A feed line is electrically connected to the radiating element and defines a feed port that is connectable to the antenna port. A ground line is electrically connected to the radiating element and defines a ground port. The first branch defines a first resonance, the second branch defines a second resonance, and the third branch defines a third resonance, all of which are superposed to define a bandwidth of the radiating element that is substantially equivalent to the predefined operating frequency band of the RF front end.

### CROSS-REFERENCE TO RELATED APPLICATIONS

This application relates to and claims the benefit of U.S. Provisional Application No. 61/357,020 filed Jun. 21, 2010 and entitled “WIDEBAND PCB-PRINTED MODIFIED MONOPOLE ANTENNA FOR RF FRONT-END IC APPLICATIONS,” U.S. Provisional Application No. 61/357,017 filed Jun. 21, 2010 and entitled “WIDEBAND PCB-PRINTED IFA ANTENNA FOR RF FRONT-END IC APPLICATIONS,” and U.S. Provisional Application No. 61/357,012 filed Jun. 21, 2010 and entitled “ULTRA-WIDEBAND AND HIGH GAIN PCB-PRINTED ANTENNA FOR RF FRONT-END IC APPLICATIONS,” each of which are wholly incorporated by reference herein.

### STATEMENT RE: FEDERALLY SPONSORED RESEARCH/DEVELOPMENT

Not Applicable

### BACKGROUND

1. Technical Field

The present disclosure relates generally to radio frequency (RF) communications and antennas, and more particularly to printed circuit board-printed antennas for use with RF integrated circuits in industrial-scientific-medical (ISM) band wireless networking.

2. Related Art

Wireless communications systems find application in numerous contexts involving information transfer over long and short distances alike, and there exists a wide range of modalities suited to meet the particular needs of each. These systems include cellular telephones and two-way radios for distant voice communications, as well as shorter-range data networks for computer systems employing technologies such as the Wireless Local Area Network (WLAN), Bluetooth, and Zigbee, among many others. Generally, wireless communications involve a radio frequency (RF) carrier signal that is variously modulated to represent data, and the modulation, transmission, receipt, and demodulation of the signal conform to a set of standards for coordination of the same.

One fundamental component of any wireless communications system is the transceiver, i.e., the transmitter circuitry and the receiver circuitry. The transceiver encodes information (whether it be digital or analog) to a baseband signal and modules the baseband signal with an RF carrier signal. Upon receipt, the transceiver down-converts the RF signal, demodulates the baseband signal, and decodes the information represented by the baseband signal. The transceiver itself typically does not generate sufficient power or have sufficient sensitivity for reliable communications. The wireless communication system therefore includes a front end module (FEM) with a power amplifier for boosting the transmitted signal, and a low noise amplifier for increasing reception sensitivity.

Another fundamental component of a wireless communications system is the antenna, which is a device that allow for the transfer of the generated RF signal from the transmitter/front end module to electromagnetic waves that propagate through space. The receiving antenna, in turn, performs the reciprocal process of turning the electromagnetic waves into an electrical signal or voltage at its terminals that is to be processed by the receiver/front end module. Oftentimes the transceiver, the front end circuit, and the antenna are incorporated on to a single printed circuit board for reducing the overall footprint of the communications system, and for reducing production costs.

Optimal performance of a communications system is dependent upon the configuration of both the antenna and the front end circuit. It is desirable for the antenna to have a high gain as well as a wide bandwidth. There must also be an adequately low return loss, ideally better than −15 dB, so that satisfactory performance of the transceiver and the front end module are maintained even when the operating point has drifted beyond a normal range. More particularly, the output matching circuit for the power amplifier and the input matching circuit for the low noise amplifier are both tuned to a standard impedance of 50 Ohm. If the return loss (S11) of the antenna is minimized to the aforementioned −15 dB level, performance degradation of the power amplifier remains negligible. As the various electrical components of communications devices are densely packed, interference between the antenna and such nearby components is also a source of performance degradation. With current antenna designs, the return loss (S11) at the edges of the operating frequency band is typically around −5 dB, leading to a reduced performance of the front end module. This, in turn, reduces the total radiated power, the total integrated sensitivity of the transceiver, and the quality of the digital signal. The cumulative effects of such performance degradations include shorter communication link distances, increased data transfer times, and a host of other problems attendant thereto.

Accordingly, there is a need in the art for printed circuit board-printed antennas that have excellent return loss, wide bandwidth, high gain, and high efficiency.

### BRIEF SUMMARY

In accordance with one embodiment of the present disclosure, a printed circuit board (PCB)-printed antenna for a radio frequency (RF) front end integrated circuit with an antenna port for a predefined operating frequency band is contemplated. The PCB-printed antenna may include a printed circuit board substrate. Additionally, there may be a radiating element that is fixed to the printed circuit board substrate. The radiating element may have a first inverted-F branch defined by a first set of dimensions corresponding to a minimum frequency in the operating frequency band and a second inverted-F branch defined by a second set of dimensions corresponding to a maximum frequency in the operating frequency band. There may also be a feed line that is electrically connected to the first inverted-F branch and the second inverted-F branch of the radiating element. The feed line may define a feed port that is connectable to the antenna port of the RF front end integrated circuit. The PCB-printed antenna may further include a ground line that is electrically connected to the first inverted-F branch and the second inverted-F branch of the radiating element. The ground line may also define a ground port. The first inverted-F branch of the radiating element may define a first resonance, and the second inverted-F branch of the radiating element may define a second resonance. The first resonance and the second resonance may, in turn, be superposed to define a bandwidth of the radiating element that is substantially equivalent to the predefined operating frequency band of the RF front end integrated circuit.

One embodiment of the present disclosure contemplates a PCB-printed antenna for RF front end integrated circuits with an antenna port for a predefined operating frequency band. Again, there may be a printed circuit board substrate, and a radiating element fixed thereto. This radiating element may gave a first inverted-F branch that is defined by a first set of dimensions corresponding to a minimum frequency in the operating frequency band, a second inverted-F branch defined by a second set of dimensions corresponding to a maximum frequency in the operating frequency band, and a third inverted-F branch defined by a third set of dimensions corresponding to a middle frequency in the operating frequency band. The PCB-printed antenna may include a feed line that is electrically connected to the radiating element. The feed line may define a feed port that is connectable to the antenna port of the RF front end integrated circuit. There may further be a ground line that is electrically connected to the radiating element. The ground line may also defining a ground port. The first inverted-F branch of the radiating element may define a first resonance, the second inverted-F branch of the radiating element may define a second resonance, and the third inverted-F branch of the radiating element may define a third resonance. The first resonance, the second resonance, and the third resonance may be superposed to define a bandwidth of the radiating element that is substantially equivalent to the predefined operating frequency band of the RF front end integrated circuit.

Another embodiment contemplates a PCB-printed antenna for an RF front end integrated circuit with an antenna port for a predefined operating frequency band. There may be a printed circuit board substrate, and a radiating element fixed thereto. The radiating element may have a first inverted-L monopole branch with a meander configuration. Additionally, the first inverted-L monopole branch may be defined by a first set of dimensions corresponding to a minimum frequency in the operating frequency band. The radiating element may also have a second inverted-L monopole branch with a straight configuration and defined by a second set of dimensions corresponding to a maximum frequency in the operating frequency band, and a third inverted-F branch having a straight configuration and defined by a third set of dimensions corresponding to a middle frequency in the operating frequency band. The PCB-printed antenna may have a feed line that is electrically connected to the radiating element. The feed line may define a feed port that is connectable to the antenna port of the RF front end integrated circuit. The first inverted-L monopole branch of the radiating element may define a first resonance, the second inverted-L monopole branch of the radiating element may define a second resonance, and the third inverted-L monopole branch of the radiating element may define a third resonance. The first resonance, the second resonance, and the third resonance may be superposed to define a bandwidth of the radiating element that is substantially equivalent to the predefined operating frequency band of the RF front end integrated circuit. The presently disclosed PCB-printed antennas will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a perspective view of a first embodiment of a printed circuit board (PCB)-printed antenna;

FIG. 2 is a top plan view of the first embodiment of the PCB-printed antenna showing a radiating element with a first branch and a second branch, a feed line, a ground line, and a tuning block;

FIG. 3 is a Smith chart illustrating a measured return loss of the first embodiment of the PCB-printed antenna without a matching circuit;

FIG. 4 is a schematic diagram of an exemplary matching circuit connectable to the first embodiment of the PCB-printed antenna;

FIG. 5 is a graph illustrating the measured return loss of the first embodiment of the PCB-printed antenna with and without a matching circuit;

FIG. 6 is a perspective view of a far-field chamber antenna radiation pattern test setup;

FIG. 7A-7B are graphs showing a measured radiation pattern of the first embodiment of the PCB-printed antenna in the X-Y plane, the X-Z plane, and the Y-Z plane, respectively;

FIG. 8 is a table illustrating the measured peak gain and radiation efficiency of the first embodiment of the PCB-printed antenna;

FIG. 9 is a perspective view of a second embodiment of a printed circuit board (PCB)-printed antenna;

FIG. 10 is a top plan view of the second embodiment of the PCB-printed antenna showing a radiating element with a first branch, a second branch, a third branch, a feed line, a ground line, and a tuning block;

FIG. 11 is a graph illustrating the measured return loss of the second embodiment of the PCB-printed antenna;

FIG. 12A-12B are graphs showing a measured radiation pattern of the second embodiment of the PCB-printed antenna in the X-Y plane, the X-Z plane, and the Y-Z plane, respectively;

FIG. 13 is a table illustrating the measured peak gain and radiation efficiency of the second embodiment of the PCB-printed antenna;

FIG. 14 is a perspective view of a third embodiment of a printed circuit board (PCB)-printed antenna;

FIG. 15 is a top plan view of the third embodiment of the PCB-printed antenna showing a radiating element with a first branch having a meander configuration, a second branch with a straight configuration, a third branch with a straight configuration, a feed line, a ground line, and a tuning block;

FIG. 16 is a graph illustrating the measured return loss of the third embodiment of the PCB-printed antenna;

FIG. 17A-17B are graphs showing a measured radiation pattern of the third embodiment of the PCB-printed antenna in the X-Y plane, the X-Z plane, and the Y-Z plane, respectively; and

FIG. 18 is a table illustrating the measured peak gain and radiation efficiency of the third embodiment of the PCB-printed antenna.

Common reference numerals are used throughout the drawings and the detailed description to indicate the same elements.

### DETAILED DESCRIPTION

A printed circuit board (PCB)-printed antenna having field-confined, wideband and high efficiency performance features is contemplated in accordance with various embodiments of the present disclosure. In one operating frequency band of 2400 MHz to 2483.5 MHz, the return loss is contemplated to be better than −19 dB. Various embodiments contemplate a bandwidth where the return loss (S11) is −10 dB to be 640 MHz, 410 MHz and 380 MHz. Additionally, the printed antenna has stable performance and not prone to degradation or detuning resulting from nearby components and from objects placed in its vicinity. The detailed description set forth below in connection with the appended drawings is intended as a description of the several presently contemplated embodiments of the antenna assembly, and is not intended to represent the only form in which the disclosed invention may be developed or utilized. The description sets forth the functions and structural features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

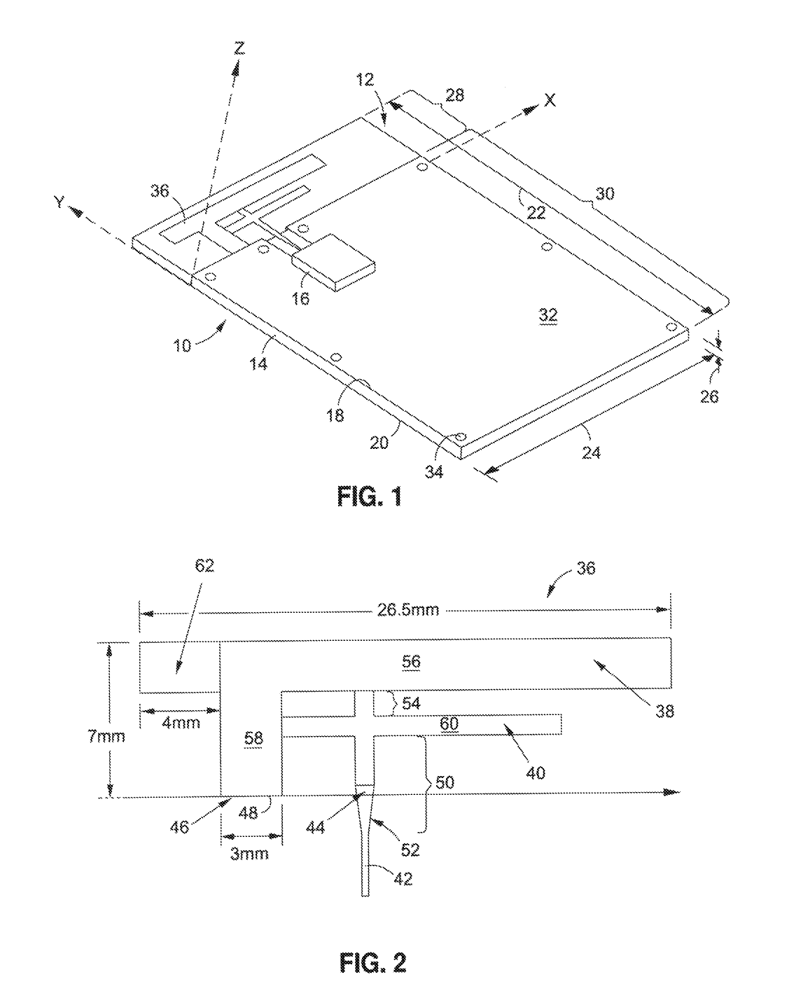

FIG. 1 depicts an antenna assembly 10 with the first embodiment of a printed antenna 12. The antenna assembly 10 includes a printed circuit board (PCB) substrate 14, to which the printed antenna 12 is affixed. Mounted to the PCB substrate 14 is a radio frequency (RF) front end integrated circuit 16. Additional electronic components necessary for wireless communications such as transceiver modules and general-purpose data processors may also be mounted to the PCB substrate 14 and electrically interconnected, but these are not shown. The PCB substrate may thus be that of a communications device such as a smart phone, a wireless networking card, and so forth. In this regard, the communications device, and hence the RF front end integrated circuit 16 is understood to implement WiFi, Bluetooth, and/or ZigBee data communications over the 2.4 GHz Industrial-Scientific-Medical (ISM) band. The presently disclosed antenna assembly 10 and printed antenna 12 need not be limited to such applications and its attendant frequency and bandwidth parameters. As will be discussed in further detail below, the operational parameters may be adjusted to meet the requirements of the intended application.

The PCB substrate 14 has a generally planar, quadrangular configuration with a top surface 18 and an opposed bottom surface 20. In the illustrated exemplary embodiment, the PCB substrate 14 has a length 22 of 50 mm, a width 24 of 40 mm, and a thickness 26 of 1.524 mm. Furthermore, for purposes of the present disclosure in illustrating the performance of the printed antenna 12, the PCB substrate has a lengthwise axis Y, widthwise axis X, and a vertical axis Z. By way of example only the PCB substrate 14 is a conventional glass-reinforced epoxy that is laminated with 1 oz. copper foil, also designated as FR4. As will be recognized, these dimensions and materials parameters such as substrate composition, conductor thickness, and the like may be modified to conform to the structural constraints of the RF communications device in which it is utilized, while still meeting the stated performance objectives of the antenna assembly 10.

As shown in FIG. 1, the PCB substrate 14 can be generally segregated into a first section 28 and a second section 30. The top surface 18 of the second section 30 includes a ground plane 32 comprised of the copper laminate. On the other hand, the top surface 18 of the first section 28 is etched and the copper laminate defines the printed antenna 12. It is understood that the ground plane 32 reduces noise and references the various electronic components mounted on the antenna assembly 10 to a common ground. Where other electronic components are mounted to the bottom surface 20 of the PCB substrate 14, there are conductive vias 34 that extend between the bottom surface 20 and the top surface 18 and electrically connect the ground or common terminals of such devices to the ground plane 32.

The printed antenna 12 includes a radiating element 36, which, as indicated above, is fixed to the PCB substrate 14. The radiating element 36 has a first inverted-F branch 38, and a second inverted-F branch 40. The first embodiment of the printed antenna 12 is specifically configured for an operating frequency band of 2.4 GHz to 2.4835 GHz. Thus, the minimum frequency signal passed to the printed antenna 12 is 2.4 GHz, and the maximum frequency signal passed to the printed antenna 12 is 2.4835 GHz. It is contemplated that a first set of dimensions of the first inverted-F branch 38 corresponds to such minimum frequency in the operating frequency band, and a second set of dimensions of the second inverted-F branch 40 corresponds to such maximum frequency in the operating frequency band. By way of example only and not of limitation, the printed antenna 12 has an overall length of 26.5 mm, and a width of 7.3 mm.

Both the first inverted-F branch 38 and the second inverted-F branch 40 are electrically connected to a feed line 42 that has an impedance of 50 Ohm, through which a signal from the RF front end integrated circuit 16 is fed. The feed line 42 also defines a feed port 44 of the printed antenna 12. Similarly, the first inverted-F branch 38 and the second inverted-F branch 40 are electrically connected to a ground line 46 that defines a ground port 48 of the printed antenna 12. In various embodiments, the feed line 42 is integrally formed with and mechanically contiguous with the radiating element 36. Along these lines, the ground line 46 is integrally formed with and mechanically contiguous with the radiating element 36.

In further detail, the first inverted-F branch 38 is fed via a shared feed section 50 that has a tapered micro-strip line 52, and an independent first feed section 54. The first inverted-F branch 38 has a primary section 56 with a straight configuration. There is a common bend section 58 that extends perpendicularly to the primary section 56 of the first inverted-F branch 38. The width of the primary section 56 and the common bend section 58 may be 3 mm. The second inverted-F branch 40 is also fed by the shared feed section 50, and includes a primary section 60 to which the shared feed section 50 is connected. The primary section 60 of the second inverted-F branch 40 has a straight configuration. The primary section 60 intersects with the shared feed section 50 and the independent first feed section 54, and is connected to the common bend section 58. The total length of the first inverted-F branch 38 is configured to be approximately a quarter of the wavelength of the minimum frequency in the operating frequency band. For a minimum operating frequency of 2.4 GHz, the quarter wavelength is understood to be approximately 31.228 mm. Similarly, the total length of the second inverted-F branch 40 is configured to be approximately a quarter of the wavelength of the maximum operating frequency of 2.4835 GHz, which is approximately 30.178 mm. It will be appreciated that these dimensions are provided by way of example only and not of limitation; the dimensions of the first and second inverted-F branches 38, 40 can be adjusted for other operating frequency bands such as 2.3 GHz to 2.7 GHz.

The first inverted-F branch 38 defines a first resonance and the second inverted-F branch 40 defines a second resonance. The multiple resonances are superposed in accordance with the principles explained in U.S. patent application Ser. No. 12/914,922 entitled “FIELD-CONFINED WIDEBAND ANTENNA FOR RADIO FREQUENCY FRONT END INTEGRATED CIRCUITS,” the disclosure of which is wholly incorporated by reference in its entirety herein. Furthermore, as will be described in further detail below, a multi-step impedance matching configuration is utilized. It is contemplated that such superposition of multiple resonances yield improved wideband performance.

Additionally, the printed antenna 12 may include a tuning block 62 that is opposite the primary section 56 of the first inverted-F branch 38. In one exemplary implementation, the tuning block 62 has a length of 4 mm and a width of 3 mm, the same as the width of the common bend section 58 as well as the primary section 56.

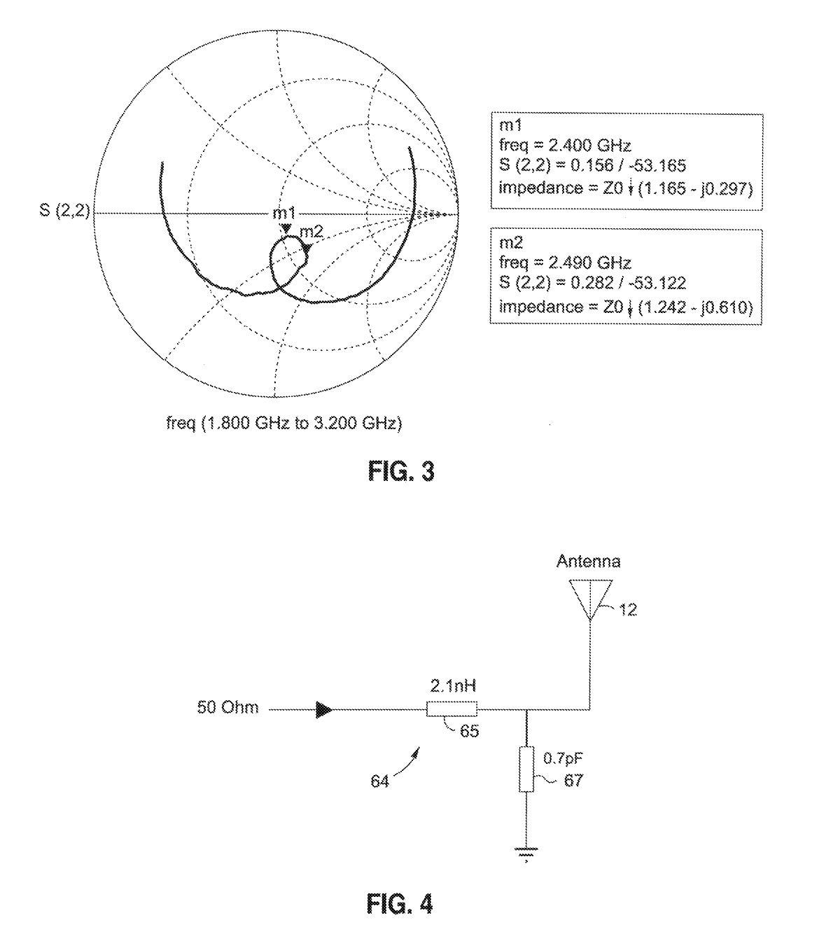

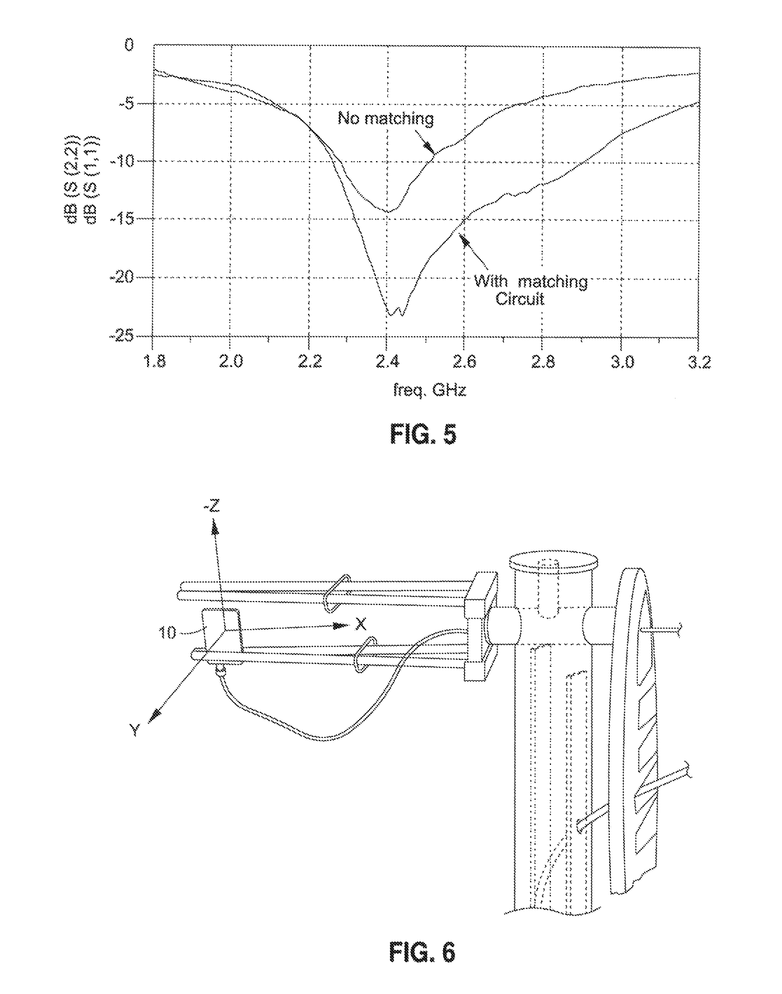

The Smith chart of FIG. 3 that charts the output reflection coefficient S22 shows that the impedance of the printed antenna 12 can be readily matched to 50 Ohms. One contemplated low-pass matching circuit 64 is shown in FIG. 4, which is comprised of an inductor 65 of 2.1 nH connected to the feed line 42, and a capacitor 67 of 0.7 pF connected to the inductor 65 and the printed antenna 12. The graph of FIG. 5 illustrates the measured return loss without the matching circuit 64 in comparison to the measured return loss with the matching circuit 64. As shown, the return loss across the 2.4 GHz to 2.49 GHz operating frequencies is better than −19 dB, and the bandwidth where the input reflection coefficient S11 is −10 dB is approximately 640 MHz.

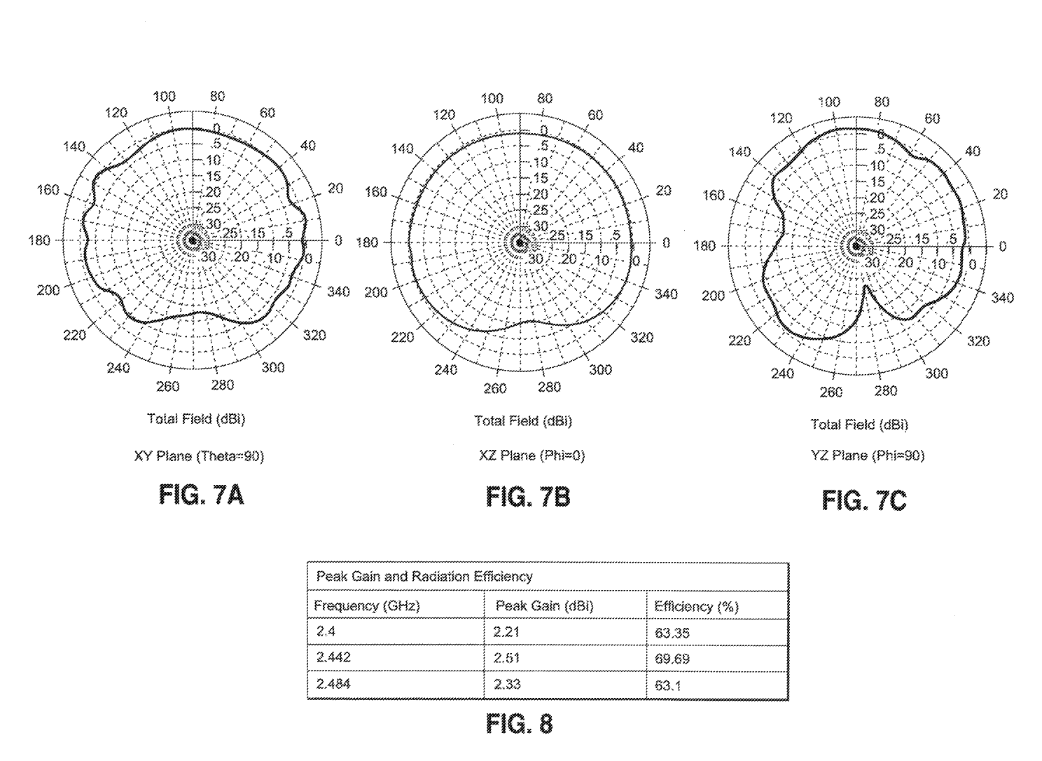

The above-described first embodiment of the printed antenna 12 is configured for the ISM 2.4 GHz operating frequency band, and its performance has been measured with a far-field anechoic chamber test setup as shown in FIG. 6. The radiation pattern of the printed antenna 12 in the X-Y plane, X-Z plane and Y-Z plane are shown in FIG. 7A, FIG. 7B, and FIG. 7C, respectively. As illustrated, the radiation pattern in XZ plane is approximately Omni-directional. As shown in the table of FIG. 8, peak gain is understood to be 2.1 dBi to 2.6 dBi across the operating frequency band of 2.4 GHz to 2.4835 GHz. Across this operating frequency band, radiation efficiency is between 63% and 69.7%. Although a specific configuration of the printed antenna 12 for the 2.4 GHz ISM operating frequency band has been described, those having ordinary skill in the art will recognize that the specific dimensions may be modified for other operating frequency bands.

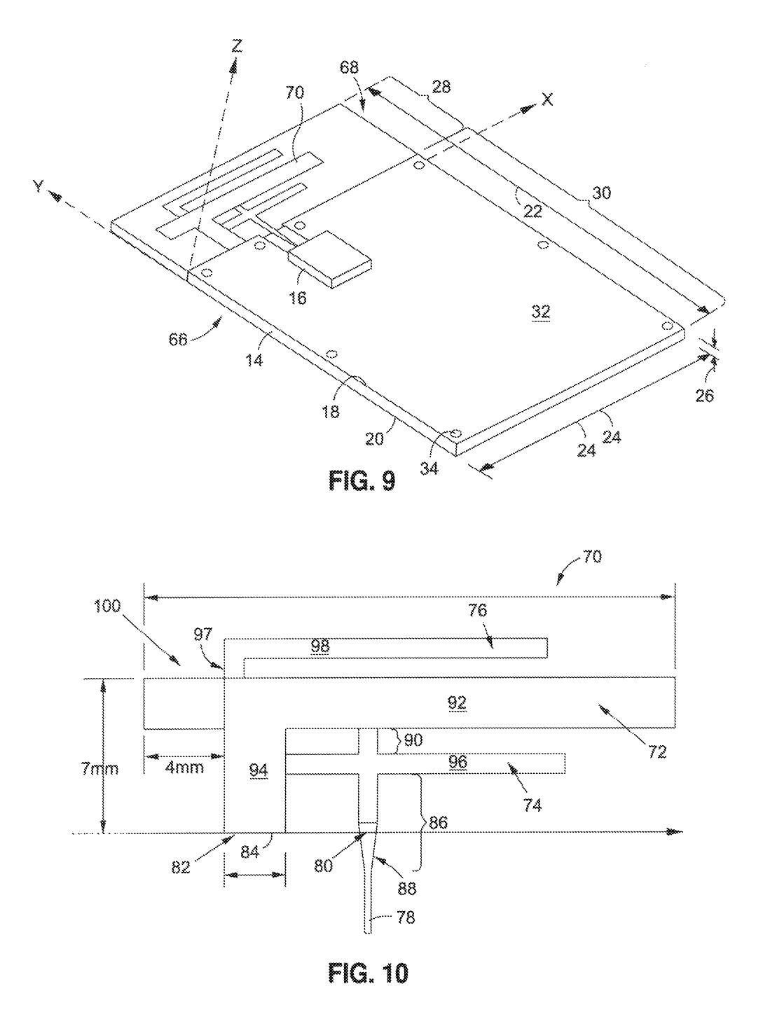

FIG. 9 depicts another antenna assembly 66 with a second embodiment of a printed antenna 68. The antenna assembly 66 includes the same PCB substrate 14 described above in relation to the antenna assembly 10. Again, the printed antenna 68 is affixed to the PCB substrate 14. Mounted to the PCB substrate 14 is the RF front end integrated circuit 16. The various top surface 18, opposed bottom surface 20, length 22, width 24, thickness 26, lengthwise axis Y, widthwise axis X, and vertical axis Z of the PCB substrate are the same as discussed earlier. Additionally, the constituent materials of the PCB are identical. In the antenna assembly 66, however, the second embodiment of the printed antenna 68 is utilized, the details of which will be described more fully below.

The second embodiment of the printed antenna 68 includes a radiating element 70 that is fixed to the PCB substrate 14. The radiating element 70 has a first inverted-F branch 72, a second inverted-F branch 74, and a third inverted-F branch 76. The second embodiment of the printed antenna 68 is likewise specifically configured for an operating frequency band of 2.4 GHz to 2.4835 GHz. Thus, the minimum frequency signal passed to the printed antenna 68 is 2.4 GHz, the maximum frequency signal passed to the printed antenna 68 is 2.4835 GHz, and the middle frequency signal passed to the printed antenna 68 is 2.442 GHz. It is contemplated that a first set of dimensions of the first inverted-F branch 72 corresponds to such minimum frequency in the operating frequency band, a second set of dimensions of the second inverted-F branch 74 corresponds to such maximum frequency in the operating frequency band, and the third set of dimensions of the third inverted-F branch 76 corresponds to the middle frequency in the operating frequency band. In the exemplary configuration shown in FIG. 10, the printed antenna 12 has an overall length of 26.5 mm, and a width of 7.3 mm.

The first inverted-F branch 72, the second inverted-F branch 74, and the third inverted-F branch 76 are electrically connected to a feed line 78 that has an impedance of 50 Ohm, through which a signal from the RF front end integrated circuit 16 is fed. The feed line 78 also defines a feed port 80 of the printed antenna 68. The first inverted-F branch 72, the second inverted-F branch 74, and the third inverted-F branch 76 are electrically connected to a ground line 82 that defines a ground port 84 of the printed antenna 68. The feed line 78 is integrally formed with and mechanically contiguous with the radiating element 70. Along these lines, the ground line 82 is integrally formed with and mechanically contiguous with the radiating element 70.

The first inverted-F branch 72 is fed by a shared feed section 86 that has a tapered micro-strip line 88, and an independent first feed section 90. This, in turn, is connected to a primary section 92, which has a straight configuration. There is a common bend section 94 that extends perpendicularly to the primary section 92 of the first inverted-F branch 72. The common bend section 94 is contiguous with the ground line 82. The width of the primary section 92 and the common bend section 94 may be 3 mm.

The second inverted-F branch 74 is also fed by the shared feed section 86, which is connected to a primary section 96. The primary section 96 of the second inverted-F branch 74 has a straight configuration. The primary section 96 intersects with the shared feed section 86 and the independent first feed section 90, and is connected to the common bend section 94. Again, the common bend section 94 is contiguous with the ground line 82.

The third inverted-F branch 76 is likewise fed by the shared feed section 86. On the side opposite the ground port 84 extends another bend section 97. A primary section 98 extends in a perpendicular relationship to the bend section 97, and has a straight configuration.

The total length of the first inverted-F branch 72 is configured to be approximately a quarter of the wavelength of the minimum frequency in the operating frequency band. For a minimum operating frequency of 2.4 GHz, the quarter wavelength is understood to be approximately 31.228 mm. Similarly, the total length of the second inverted-F branch 74 is configured to be approximately a quarter of the wavelength of the maximum operating frequency of 2.4835 GHz, which is approximately 30.178 mm. The total length of the third inverted-F branch 76 is configured to be approximately a quarter of the wavelength of the middle operating frequency of 2.422 GHz, which is understood to be approximately 30.944 mm. These dimensions are provided by way of example only and not of limitation. the dimensions of the first, second and third inverted-F branches 72, 74, and 76 can be adjusted for other operating frequency bands such as 2.3 GHz to 2.7 GHz.

The first inverted-F branch 72 defines a first resonance, the second inverted-F branch 74 defines a second resonance, and the third inverted-F branch 76 defines a third resonance. The multiple resonances are superposed in accordance with the earlier mentioned principles. It is contemplated that such superposition of multiple resonances yield improved wideband performance.

Additionally, the printed antenna 68 may include a tuning block 62 that is opposite the primary section 92 of the first inverted-F branch 72. The tuning block 62 may have a length of 4 mm and a width of 3 mm, the same as the width of the common bend section 94 as well as the primary section 92.

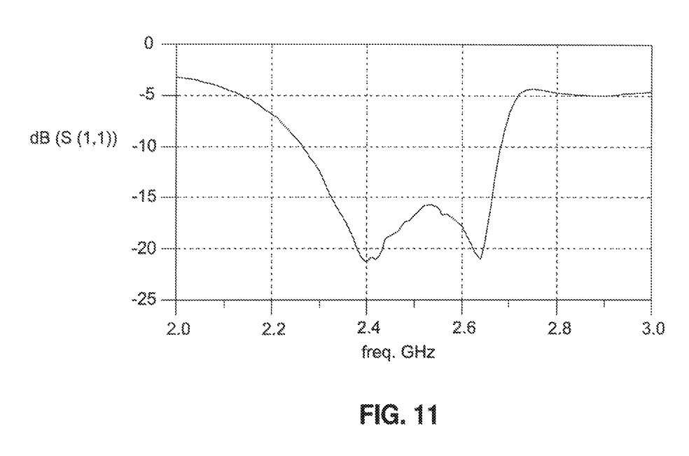

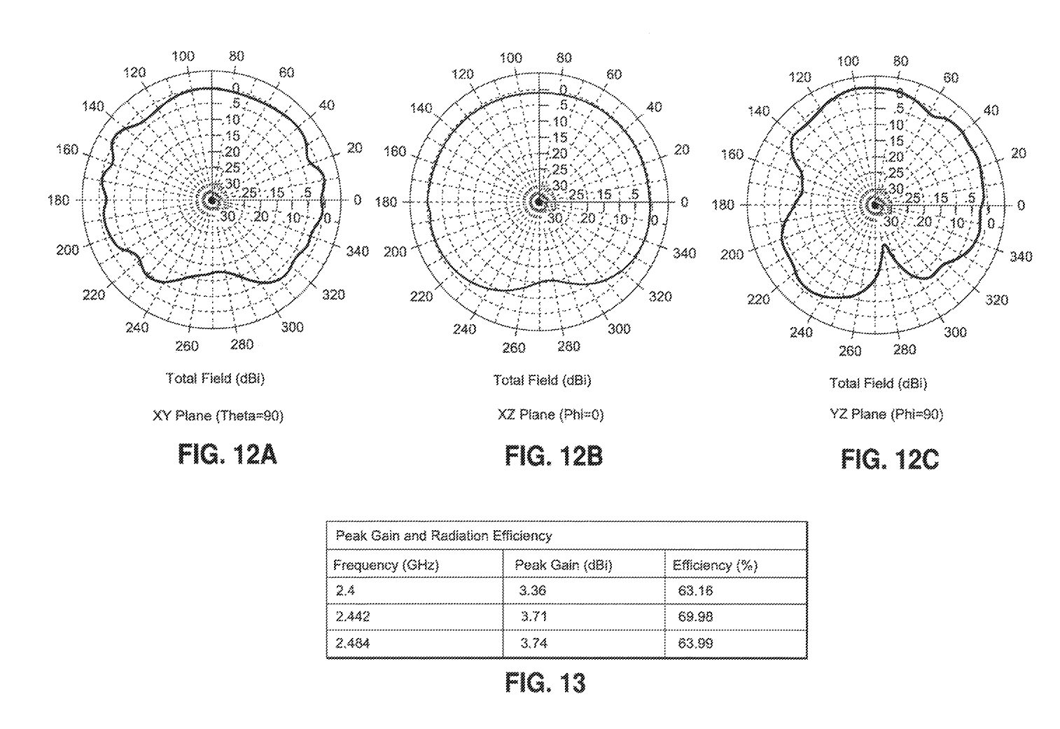

The above-described second embodiment of the printed antenna 68 is configured for the ISM 2.4 GHz operating frequency band, and its performance has been measured with the far-field anechoic chamber test setup discussed above with reference to FIG. 6. As shown in the graph of FIG. 11, the printed antenna 68 is contemplated to have a wide bandwidth and excellent return loss characteristics. In particular, the return loss is better than −16 dB across the operating frequency band of 2.4 GHz to 2.4835 GHz, and the bandwidth where the input reflection coefficient S11 is −10 dB is approximately 410 MHz. The radiation pattern of the printed antenna 68 in the X-Y plane, X-Z plane and Y-Z plane are shown in FIG. 12A, FIG. 12B, and FIG. 12C, respectively. The radiation pattern in XZ plane is approximately omni-directional. The table of FIG. 13 shows that peak gain is 3.3 dBi to 3.74 dBi across the operating frequency band of 2.4 GHz to 2.4835 GHz. Across this operating frequency band, radiation efficiency is between 63% and 70%. Although a specific configuration of the second embodiment of the printed antenna 68 for the 2.4 GHz ISM operating frequency band has been described, it will be appreciated that the specific dimensions may be modified for other operating frequency bands.

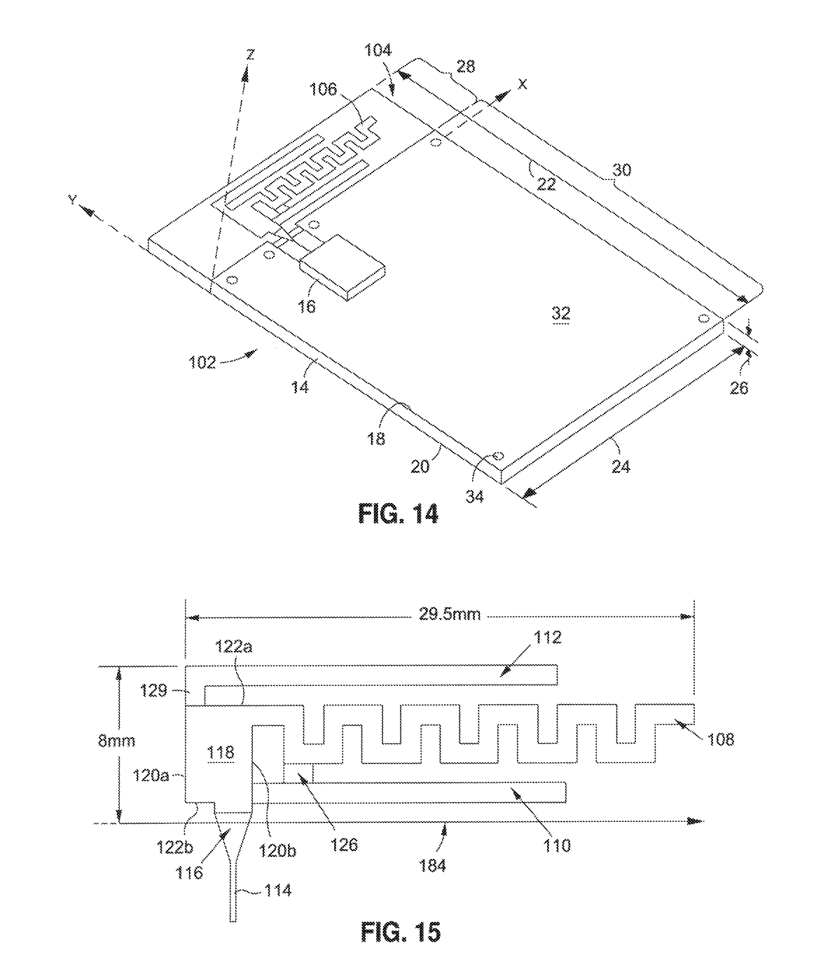

FIG. 14 depicts another antenna assembly 102 with a third embodiment of a printed antenna 104. The antenna assembly 102 includes the same PCB substrate 14 described above in relation to the antenna assembly 10. The printed antenna 104 is affixed to the PCB substrate 14, and mounted thereto is the RF front end integrated circuit 16. The various top surface 18, opposed bottom surface 20, length 22, width 24, thickness 26, lengthwise axis Y, widthwise axis X, and vertical axis Z of the PCB substrate are the same as discussed earlier. Additionally, the constituent materials of the PCB are the same. In the antenna assembly 102, however, the third embodiment of the printed antenna 104 is utilized, the details of which will be described more fully below.

The third embodiment of the printed antenna 104 includes a radiating element 106 that is fixed to the PCB substrate 14. The radiating element 106 has a first inverted-L monopole branch 108, a second inverted-L monopole branch 110, and a third inverted-L monopole branch 112. The third embodiment of the printed antenna 104 is specifically configured for an operating frequency band of 2.4 GHz to 2.4835 GHz. Thus, the minimum frequency signal passed to the printed antenna 104 is 2.4 GHz, the maximum frequency signal passed to the printed antenna 104 is 2.4835 GHz, and the middle frequency signal passed to the printed antenna 104 is 2.442 GHz. A first set of dimensions of the first inverted-L monopole branch 108 corresponds to such minimum frequency in the operating frequency band, a second set of dimensions of the second inverted-L monopole branch 110 corresponds to such maximum frequency in the operating frequency band, and the third set of dimensions of the third inverted-L monopole branch 112 corresponds to the middle frequency in the operating frequency band. In the exemplary configuration shown in FIG. 15, the printed antenna 12 has an overall length of 29.5 mm, and a width of 8 mm.

The first inverted-L monopole branch 108, the second inverted-L monopole branch 110, and the third inverted-L monopole branch 112 are electrically connected to a feed line 114 that has a tapered configuration, through which a signal from the RF front end integrated circuit 16 is fed. The feed line 114, which has an impedance of 50 Ohm, also defines a feed port 116 of the printed antenna 104. The feed line 114 is integrally formed with and mechanically contiguous with the radiating element 106.

The first inverted-L monopole branch 108 is fed by a shared feed section 118 that is electrically connected to the feed line 114. Generally, the shared feed section 118 has a quadrangular configuration with opposed first and second vertical sides 120a, 120b, and opposed first and second lateral sides 122a, 122b which are perpendicular thereto. The first inverted-L monopole branch 108 extends from the second vertical side 120b toward the first lateral side 122a, and has a meander configuration as shown. The second inverted-L monopole branch 110 extends from the shared feed section 118, particularly the second vertical side 120b thereof toward the second lateral side 122b. The second inverted-L monopole branch 110 has a straight configuration. The third inverted-L monopole branch 112 has a first bend section 124 that extends from the first vertical side 120a of the shared feed section 118, but extends in a coplanar relationship to the first inverted-L monopole branch 108 and the second inverted-L monopole branch 110.

The total length of the first inverted-L monopole branch 108 is configured to be approximately a quarter of the wavelength of the minimum frequency in the operating frequency band. For a minimum operating frequency of 2.4 GHz, the quarter wavelength is understood to be approximately 31.228 mm. Similarly, the total length of the second inverted-L monopole branch 110 is configured to be approximately a quarter of the wavelength of the maximum operating frequency of 2.4835 GHz, which is approximately 30.178 mm. The total length of the third inverted-L monopole branch 112 is configured to be approximately a quarter of the wavelength of the middle operating frequency of 2.422 GHz, which is understood to be approximately 30.944 mm. These dimensions are provided by way of example only and not of limitation, and the dimensions of the first, second and third inverted-L monopole branches 108, 110, and 112 can be adjusted for other operating frequency bands such as 2.3 GHz to 2.7 GHz. The printed antenna 104 may include a tuning block 126 connected to the first inverted-L monopole branch 108 and the second inverted-L monopole branch 110.

The first inverted-L monopole branch 108 defines a first resonance, the second inverted-L monopole branch 110 defines a second resonance, and the third inverted-L monopole branch 112 defines a third resonance. The multiple resonances are superposed in accordance with the earlier mentioned principles. It is contemplated that such superposition of multiple resonances yield improved wideband performance.

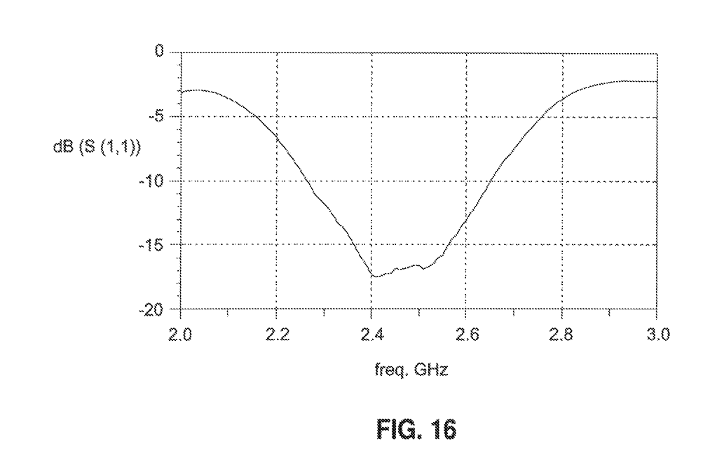

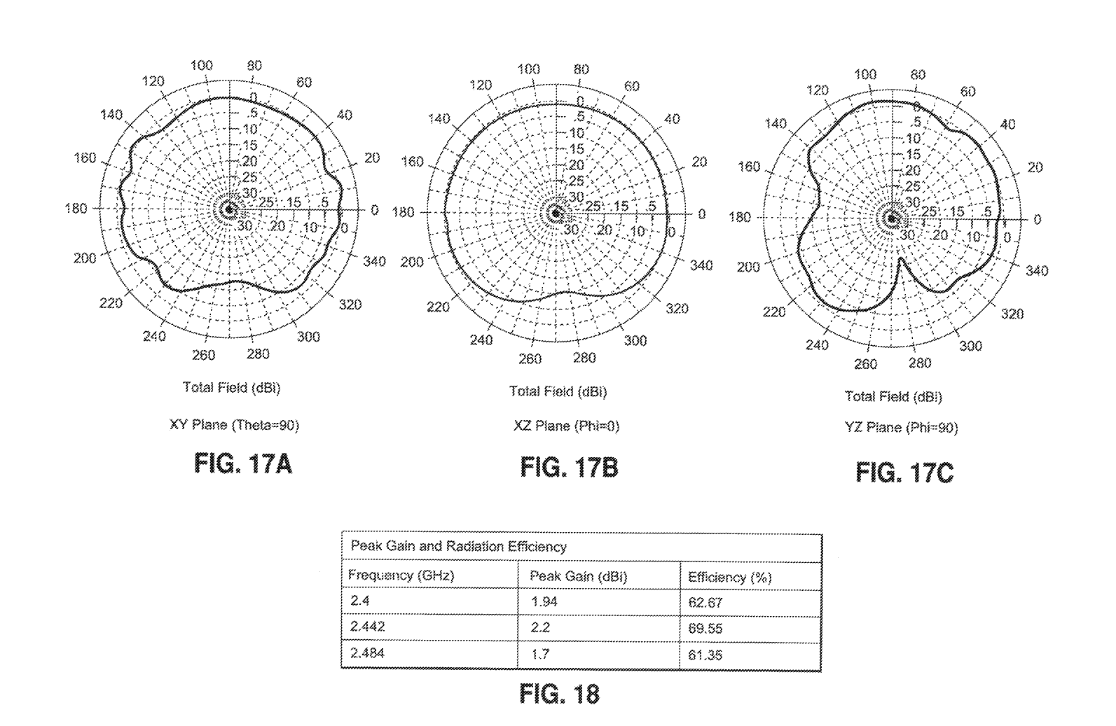

The above-described third embodiment of the printed antenna 104 is configured for the ISM 2.4 GHz operating frequency band, and its performance has been measured with the far-field anechoic chamber test setup discussed above with reference to FIG. 6. As shown in the graph of FIG. 16, the printed antenna 104 is contemplated to have a wide bandwidth and excellent return loss characteristics. In particular, the return loss is better than −16 dB across the operating frequency band of 2.4 GHz to 2.4835 GHz, and the bandwidth where the input reflection coefficient S11 is −10 dB is approximately 380 MHz. The radiation pattern of the printed antenna 104 in the X-Y plane, X-Z plane and the Y-Z plane are shown in FIG. 17A, FIG. 17B, and FIG. 17C, respectively. The radiation pattern in XZ plane is approximately Omni-directional. The table of FIG. 18 shows that peak gain is 1.7 dBi to 2.2 dBi across the operating frequency band of 2.4 GHz to 2.4835 GHz. Across this operating frequency band, radiation efficiency is between 61% and 70%. A specific configuration of the third embodiment of the printed antenna 104 for the 2.4 GHz ISM operating frequency band has been described, but it will be appreciated that the specific dimensions may be modified for other operating frequency bands.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention with more particularity than is necessary for the fundamental understanding of the present invention, the description taken with the drawings making apparent to those skilled in the art how the several forms of the present invention may be embodied in practice.

What is claimed is:

1. A printed circuit board (PCB)-printed antenna for a radio frequency (RF) front end integrated circuit with an antenna port for a predefined operating frequency band, the PCB-printed antenna comprising:
a printed circuit board substrate;
a radiating element fixed to the printed circuit board substrate and having a first inverted-F branch defined by a first set of dimensions corresponding to a minimum frequency in the operating frequency band and a second inverted-F branch defined by a second set of dimensions corresponding to a maximum frequency in the operating frequency band;
a feed line electrically connected to the first inverted-F branch and the second inverted-F branch of the radiating element, the feed line defining a feed port connectable to the antenna port of the RF front end integrated circuit;
a ground line electrically connected to the first inverted-F branch and the second inverted-F branch of the radiating element, the ground line defining a ground port;
wherein the first inverted-F branch of the radiating element defines a first resonance and the second inverted-F branch of the radiating element defines a second resonance, the first resonance and the second resonance being superposed to define a bandwidth of the radiating element substantially equivalent to the predefined operating frequency band of the RF front end integrated circuit.

2. The PCB-printed antenna of claim 1, wherein the first inverted-F branch and the second inverted-F branch of the radiating element have a straight configuration.

3. The PCB-printed antenna of claim 1, wherein:
a one of the first set of dimensions of the first inverted-F branch of the radiating element is a quarter wavelength of the minimum frequency in the operating frequency band; and
a one of the second set of dimensions of the second inverted-F branch of the radiating element is a quarter wavelength of the maximum frequency in the operating frequency band.

4. The PCB-printed antenna of claim 3, wherein:
the minimum frequency in the operating frequency band is 2.4 GHz; and
the maximum frequency in the operating frequency band is 2.4835 GHz.

5. The PCB-printed antenna of claim 3, wherein:
the minimum frequency in the operating frequency band is 2.3 GHz; and
the maximum frequency in the operating frequency band is 2.7 GHz.

6. The PCB-printed antenna of claim 1, further comprising:
a tuning block connected to the first inverted-F branch of the radiating element.

7. The PCB-printed antenna of claim 1, wherein the printed circuit board substrate is defined by a top surface and an opposed bottom surface, the radiating element being fixed to the top surface.

8. The PCB-printed antenna of claim 1, wherein:
the feed line is integrally formed and mechanically contiguous with the radiating element; and
the ground line is integrally formed and mechanically contiguous with the radiating element.

9. The PCB-printed antenna of claim 1, wherein the RF front end integrated circuit is mounted on the substrate.

10. The PCB-printed antenna of claim 9, wherein the RF front end integrated circuit is electrically connected to the feed port over a tapered microstrip line.

11. The PCB-printed antenna of claim 10, further comprising:
an impedance matching circuit electrically connected to the feed port.

12. The PCB-printed antenna of claim 10, wherein the tapered microstrip line has an impedance of 50 Ohms, matched to the impedance of the RF front end integrated circuit at the antenna port.

13. The PCB-printed antenna of claim 1, wherein the printed circuit board substrate conforms to the National Electrical Manufacturers Association (NEMA) FR-4 glass reinforced epoxy laminate specification having a 60 mil thickness.

14. A printed circuit board (PCB)-printed antenna for a radio frequency (RF) front end integrated circuit with an antenna port for a predefined operating frequency band, the PCB-printed antenna comprising:
a printed circuit board substrate;
a radiating element fixed to the printed circuit board substrate and having a first inverted-F branch defined by a first set of dimensions corresponding to a minimum frequency in the operating frequency band, a second inverted-F branch defined by a second set of dimensions corresponding to a maximum frequency in the operating frequency band, and a third inverted-F branch defined by a third set of dimensions corresponding to a middle frequency in the operating frequency band;
a feed line electrically connected to the radiating element, the feed line defining a feed port connectable to the antenna port of the RF front end integrated circuit;
a ground line electrically connected to the radiating element, the ground line defining a ground port;
wherein the first inverted-F branch of the radiating element defines a first resonance, the second inverted-F branch of the radiating element defines a second resonance, and the third inverted-F branch of the radiating element defines a third resonance, the first resonance, the second resonance, and the third resonance being superposed to define a bandwidth of the radiating element substantially equivalent to the predefined operating frequency band of the RF front end integrated circuit.

15. The PCB-printed antenna of claim 14, wherein the first inverted-F branch and the second inverted-F branch of the radiating element have a straight configuration.

16. The PCB-printed antenna of claim 14, wherein:
a one of the first set of dimensions of the first inverted-F branch of the radiating element is a quarter wavelength of the minimum frequency in the operating frequency band;
a one of the second set of dimensions of the second inverted-F branch of the radiating element is a quarter wavelength of the maximum frequency in the operating frequency band; and
a one of the third set of dimensions of the third inverted-F branch of the radiating element is a quarter wavelength of the middle frequency in the operating frequency band.

17. The PCB-printed antenna of claim 16, wherein:
the minimum frequency in the operating frequency band is 2.4 GHz;
the maximum frequency in the operating frequency band is 2.4835 GHz; and
the middle frequency in the operating frequency band is 2.442 GHz.

18. The PCB-printed antenna of claim 16, wherein:
the minimum frequency in the operating frequency band is 2.3 GHz;
the maximum frequency in the operating frequency band is 2.7 GHz; and
the middle frequency in the operating frequency band is 2.5 GHz.

19. The PCB-printed antenna of claim 14, further comprising:
a tuning block connected to the first inverted-F branch of the radiating element.

20. The PCB-printed antenna of claim 14, wherein the printed circuit board substrate is defined by a top surface and an opposed bottom surface, the radiating element being fixed to the top surface.

21. The PCB-printed antenna of claim 14, wherein:
the feed line is integrally formed and mechanically contiguous with the radiating element; and
the ground line is integrally formed and mechanically contiguous with the radiating element.

22. The PCB-printed antenna of claim 14, wherein the RF front end integrated circuit is mounted on the substrate.

23. The PCB-printed antenna of claim 22, wherein the RF front end integrated circuit is electrically connected to the feed port over a tapered microstrip line.

24. The PCB-printed antenna of claim 23, wherein the tapered microstrip line has an impedance of 50 Ohms, matched to the impedance of the RF front end integrated circuit at the antenna port.

25. The PCB-printed antenna of claim 14, wherein the printed circuit board substrate conforms to the National Electrical Manufacturers Association (NEMA) FR-4 glass reinforced epoxy laminate specification having a 60 mil thickness.

26. A printed circuit board (PCB)-printed antenna for a radio frequency (RF) front end integrated circuit with an antenna port for a predefined operating frequency band, the PCB-printed antenna comprising:
a printed circuit board substrate;
a radiating element fixed to the printed circuit board substrate and having a first inverted-L monopole branch having a meander configuration and defined by a first set of dimensions corresponding to a minimum frequency in the operating frequency band, a second inverted-L monopole branch having a straight configuration and defined by a second set of dimensions corresponding to a maximum frequency in the operating frequency band, and a third inverted-L monopole branch having a straight configuration and defined by a third set of dimensions corresponding to a middle frequency in the operating frequency band;
a feed line electrically connected to the radiating element, the feed line defining a feed port connectable to the antenna port of the RF front end integrated circuit;
wherein the first inverted-L monopole branch of the radiating element defines a first resonance, the second inverted-L monopole branch of the radiating element defines a second resonance, and the third inverted-L monopole branch of the radiating element defines a third resonance, the first resonance, the second resonance, and the third resonance being superposed to define a bandwidth of the radiating element substantially equivalent to the predefined operating frequency band of the RF front end integrated circuit.

27. The PCB-printed antenna of claim 26, wherein:
a one of the first set of dimensions of the first inverted-L monopole branch of the radiating element is a quarter wavelength of the minimum frequency in the operating frequency band;
a one of the second set of dimensions of the second inverted-L monopole branch of the radiating element is a quarter wavelength of the maximum frequency in the operating frequency band; and
a one of the third set of dimensions of the third inverted-L monopole branch of the radiating element is a quarter wavelength of the middle frequency in the operating frequency band.

28. The PCB-printed antenna of claim 27, wherein:
the minimum frequency in the operating frequency band is 2.4 GHz;
the maximum frequency in the operating frequency band is 2.4835 GHz; and
the middle frequency in the operating frequency band is 2.442 GHz.

29. The PCB-printed antenna of claim 27, wherein:
the minimum frequency in the operating frequency band is 2.3 GHz;
the maximum frequency in the operating frequency band is 2.7 GHz; and
the middle frequency in the operating frequency band is 2.5 GHz.

30. The PCB-printed antenna of claim 26, further comprising:
a tuning block connected to the first inverted-L monopole branch and to the second inverted-L monopole branch of the radiating element.

31. The PCB-printed antenna of claim 26, wherein the printed circuit board substrate is defined by a top surface and an opposed bottom surface, the radiating element being fixed to the top surface.

32. The PCB-printed antenna of claim 26, wherein:
the feed line is integrally formed and mechanically contiguous with the radiating element.

33. The PCB-printed antenna of claim 26, wherein the RF front end integrated circuit is mounted on the substrate.

34. The PCB-printed antenna of claim 33, wherein the RF front end integrated circuit is electrically connected to the feed port over a tapered microstrip line.

35. The PCB-printed antenna of claim 34, wherein the tapered microstrip line has an impedance of 50 Ohms, matched to the impedance of the RF front end integrated circuit at the antenna port.

36. The PCB-printed antenna of claim 26, wherein the printed circuit board substrate conforms to the National Electrical Manufacturers Association (NEMA) FR-4 glass reinforced epoxy laminate specification having a 60 mil thickness.
